(19) United States
(12) Patent Application Publication
(10) Pub. No.: US 2009/0164903 A1
(43) Pub. Date: Jun. 25, 2009

(54) SYSTEMS, METHODS AND COMPUTER PROGRAM PRODUCTS FOR A DYNAMIC DISPLAY OF SAVED BOOKMARKS BASED ON BROWSING ACTIVITY

(75) Inventor: Jayesh B. Patel, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/961,538

(22) Filed: Dec. 20, 2007

(51) Int. Cl. G06F 3/00

(52) U.S. Cl. 715/721

(57) ABSTRACT

Systems, methods and computer program products for a dynamic display of saved bookmarks based on browsing activity. Exemplary embodiments include a method including receiving a set of menu entries for a bookmark menu, each of the menu entries representing a bookmark, the menu entries having a first position and a bottom nth position, displaying the set of menu entries on a display, for each menu entry of the set of menu entries that is selected receiving a menu entry selection signal indicative of a selection device pointing at a selected menu entry from the set of menu entries, navigating to a network address associated with the menu entry; and placing the selected menu entry at the first position.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to network browsers, and particularly to systems, methods and computer program products for a dynamic display of saved bookmarks based on browsing activity.

2. Description of Background

Modern network browsers such as INTERNET EXPLORER, include a pull down menu onto which users may store network links and files that they access from the browser. The pull-down menus are often referred to as “Favorites” or “Bookmarks” and can be accessed via the aforementioned pull-down menu or from a tool bar menu displayed on the browser. The “Favorites” or “Bookmarks” pull-down menu lacks certain features that allow the user to access the desired network links simply and conveniently.

### SUMMARY OF THE INVENTION

Exemplary embodiments include a method including receiving a set of menu entries for a bookmark menu, each of the menu entries representing a bookmark, the menu entries having a first position and a bottom nth position, displaying the set of menu entries on a display, for each menu entry of the set of menu entries that is selected receiving a menu entry selection signal indicative of a selection device pointing at a selected menu entry from the set of menu entries, navigating to a network address associated with the menu entry; and placing the selected menu entry at the first position.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides systems, methods and computer program products that aid a user in avoiding boring and repetitive tasks for finding the link which the user has used in a previous time period. In addition, the user does have to go to folders and subfolders to locate a desired link. The systems, methods and computer products described herein can be useful for users with who have basic computer skills. For example, sometimes when a user goes to a Folder→Subfolder, the associated mouse movement may be inaccurate. As such, links from different subfolders may be displayed so he/she has to go to original subfolders and select the link, which can be confusing for the user

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for dynamically displaying saved bookmarks based on browsing activity;

FIG. 2 illustrates a screen shot of a pull-down menu illustrating links and folders in accordance with exemplary embodiments;

FIG. 3 illustrates a screen shot of a pull-down menu illustrating an example of a folder and associated link used in a daily activity;

FIG. 4 illustrates a screenshot of a pull-down menu illustrating an example of a folder, sub-folder and associated link used in an irregular non-daily activity;

FIG. 5 illustrates a screen shot of a pull-down menu in accordance with exemplary embodiments;

FIG. 6 illustrates a screen shot of a pull-down menu in accordance with exemplary embodiments;

FIG. 7 illustrates a screen shot of a pull-down menu in accordance with exemplary embodiments;

FIG. 8 illustrates a screen shot of a pull-down menu displaying the three most recently visited links in accordance with exemplary embodiments;

FIG. 9 illustrates a table defining an algorithm in accordance with exemplary embodiments; and

FIGS. 10A-10B illustrates a flowchart of a method for a dynamic display of saved bookmarks based on browsing activity in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments include systems, methods and computer program products that provide dynamic favorite/bookmark (network link) movement from current network links. In exemplary embodiments, the systems, methods and computer program products described herein access the bookmarked links for repetitive actions.

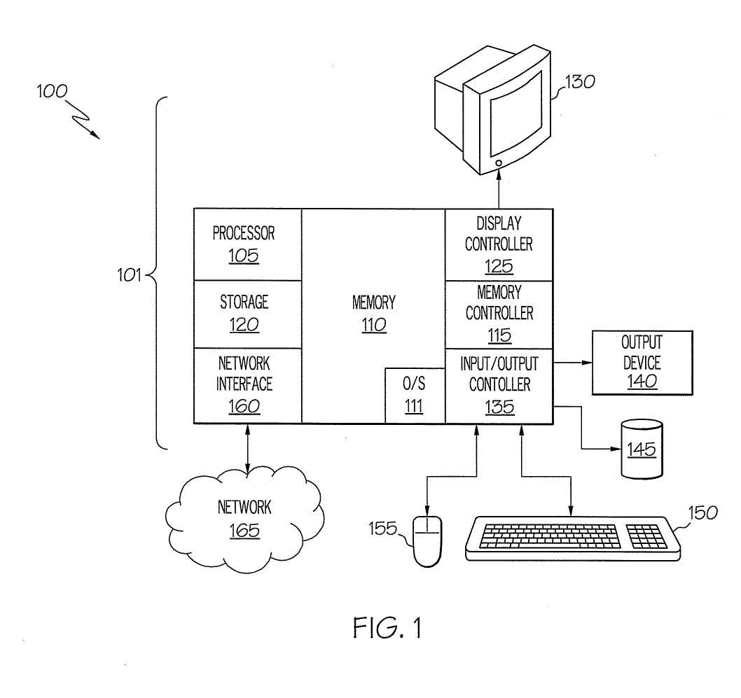

FIG. 1 illustrates an exemplary embodiment of a system 100 for dynamically displaying saved bookmarks based on browsing activity. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the dynamic bookmark display methods described herein in accordance with exemplary embodiments and a suitable operating system (OS) 111. The operating system 111 essentially controls the execution of other computer programs, such the dynamic bookmark display systems and methods described herein, and provides scheduling, input-output control, file and data management, memory management, and communication control and related services.

The dynamic bookmark display methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the O/S 111. Furthermore, the dynamic bookmark display methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The dynamic bookmark display methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The dynamic bookmark display methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the dynamic bookmark display methods are implemented in hardware, the dynamic bookmark display methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

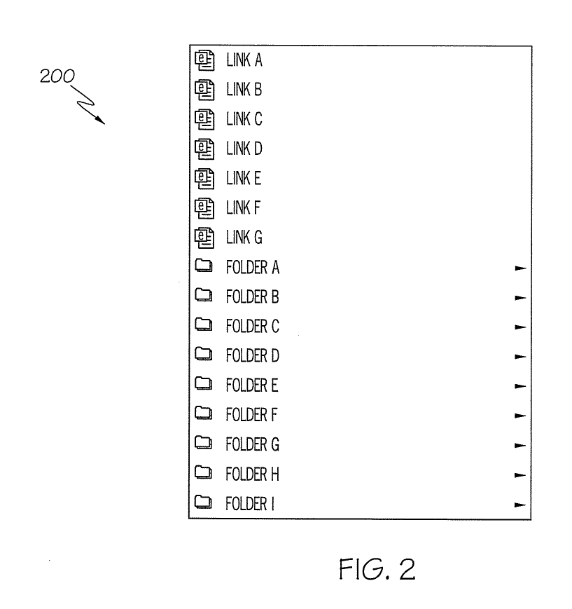

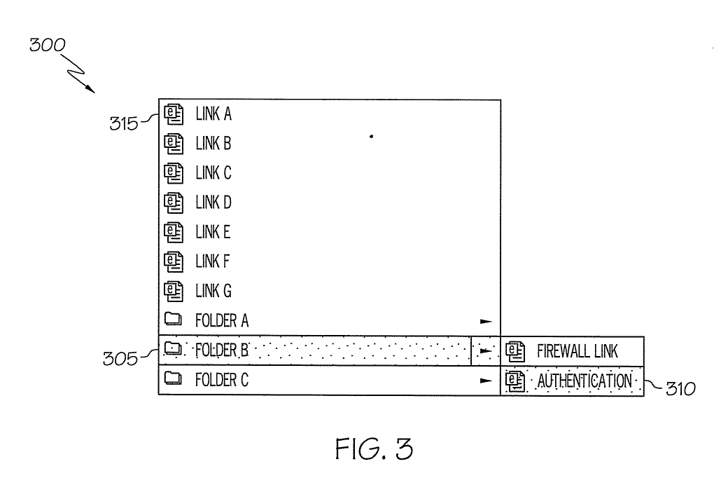

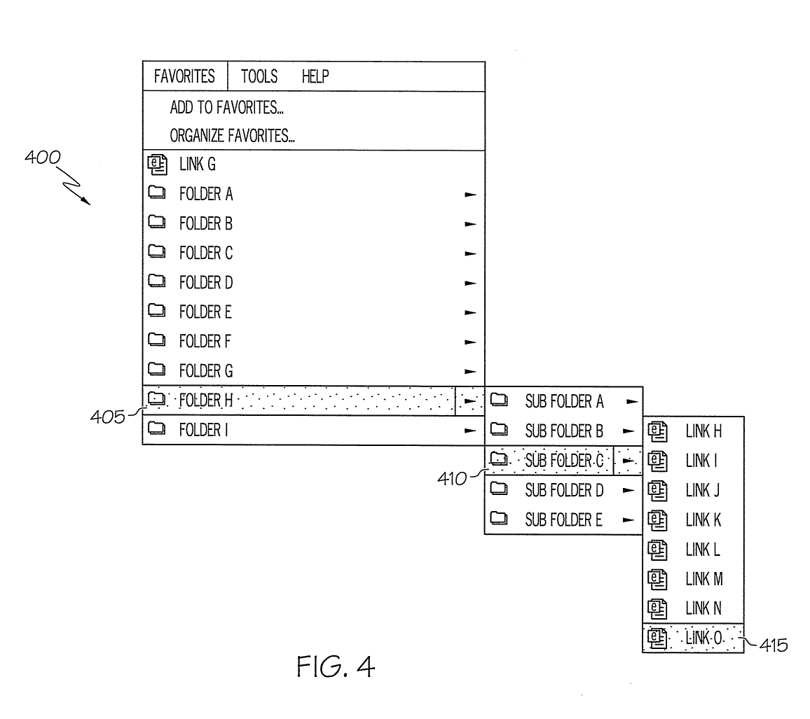

FIG. 2 illustrates a screen shot of a pull-down menu 200 illustrating links and folders in accordance with exemplary embodiments. The pull-down menu 200 illustrates several links/folders that a user has saved as “favorite” or “bookmarked” links/folders as known in the art. In exemplary embodiments, a user can save links/folders that the user uses often (e.g., daily). For example, FIG. 3 illustrates a screenshot of a pull-down menu 300 illustrating an example of a folder B 305 and associated link 310 used in a daily activity. In this example, the user has selected the folder B 305 and selected authentication link 310. The user may also select other links such as CMVC Web Application 315. In addition to daily activities, the user may also engage in irregular activities that occur infrequently. However, the activities may still involve important links. For example, FIG. 4 illustrates a screenshot of a pull-down menu 400 illustrating an example of a folder-H 405, sub-folder-C 410 and associated link-O 415 used in an irregular non-daily activity. In this example, the user has stored a link-O 415 under the folder-H 405 and the sub-folder-C 410. The user may have browsed the page associated with the link-O 415 a week earlier and now desires to access the same link-O 415. Typically, the user follows the same steps to access the link-O 415, that is pull-down the “favorites” menu 400, access the folder 405, sub-folder-C 410 then the link-O 415. The link-O 415 is therefore a static link, that is, a link that is stored the same way it is stored when originally saved.

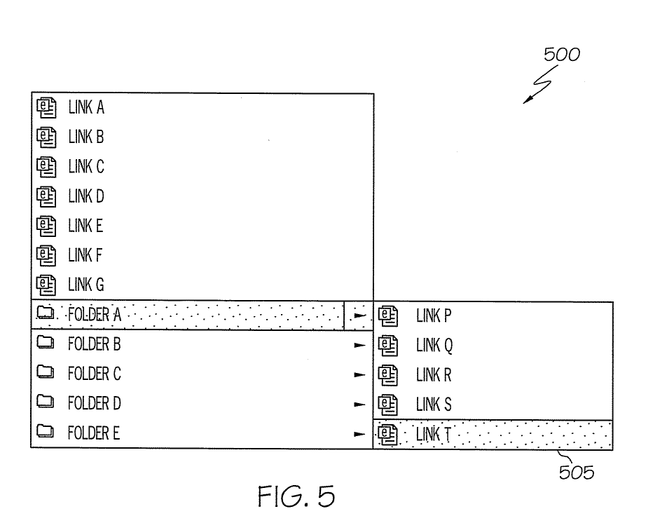

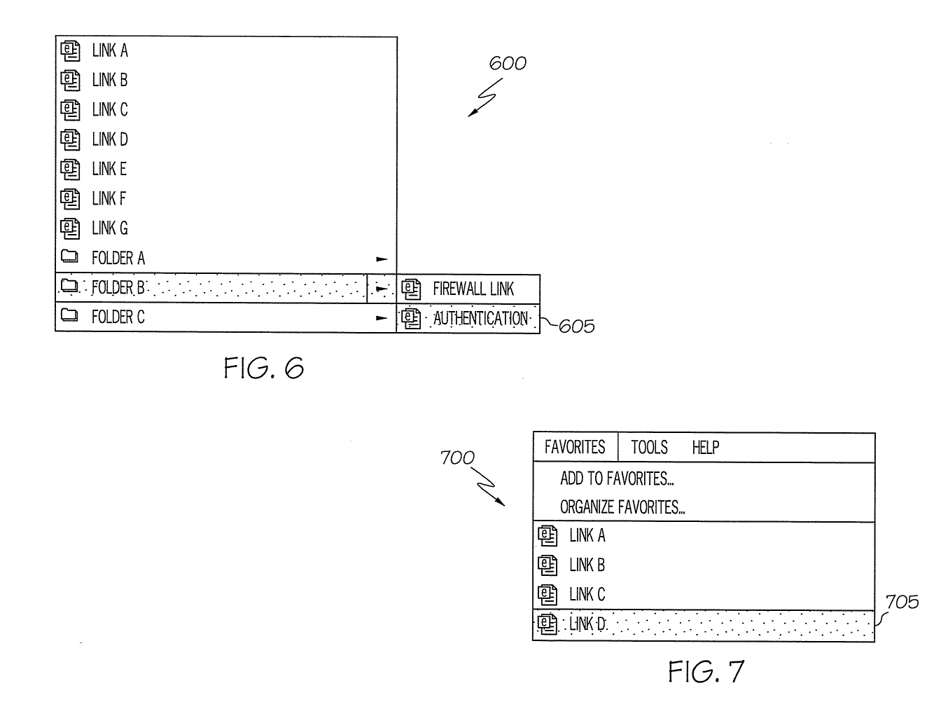

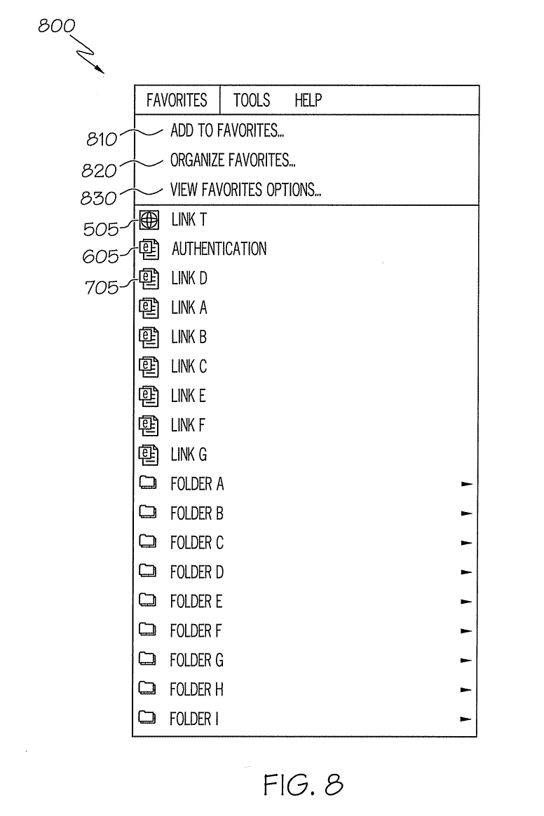

Exemplary embodiments described herein store favorite and bookmarked links dynamically, thereby changing order and display of the links dynamically as accessed by the user. In exemplary embodiments, a new link is added to the pull-down menu (e.g., pull-down menus 200, 300, 400) from a different view, such as at the top of the pull-down menu. In exemplary embodiments, internally in the system 100, the new link is pointing to the original link, which is also still present in the pull-down menu. However, as described, the view in which the link is displayed dynamically changes for browsed pages based on a time specified as described herein. For example, the user can specify to display links that have been visited in desired time periods (e.g., one hour, one day one week). FIGS. 5-7 illustrate screen shots of pull-down menus 500, 600, 700 and selected links 505, 605, 705 in accordance with exemplary embodiments. In each of FIGS. 5-7, the user has selected a particular links 505, 605 and 705 respectively for viewing and navigation:

http://Link T

http://Authentication

http://Link D

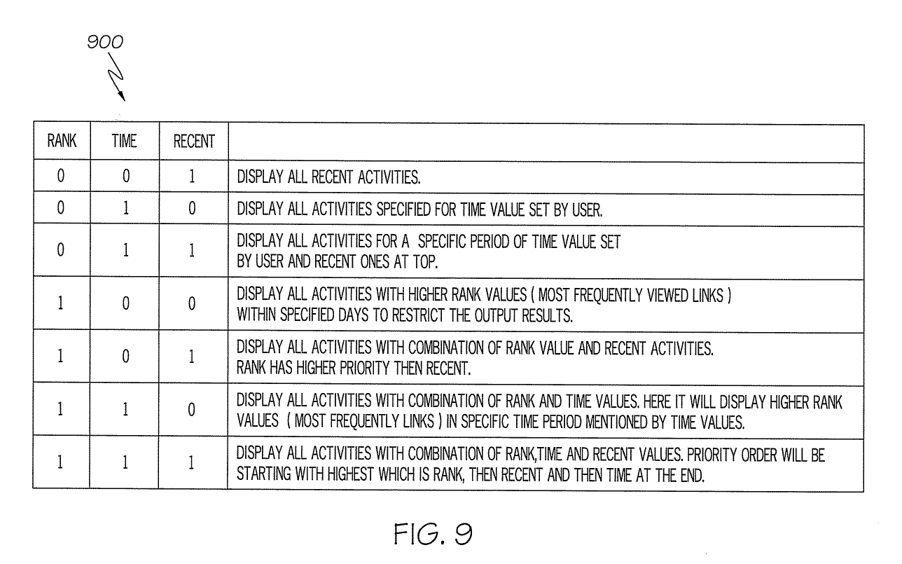

It is appreciated that if the user then desires to access the identical links 505, 605, 705 at some time period later, such as one hour, currently, the user must re-navigate the pull-down menus 500, 600, 700 in the identical manner as illustrated in FIGS. 5-7. In exemplary embodiments, the systems and methods described herein can move the links 505, 605, 705 to the top view of the pull-down menu 500, 600, 700. In addition, the original links remain statically placed in their original locations. Then after the specified time period (e.g., one hour) the links can be removed from the top view. Therefore, during the specified time period, navigated links are dynamically placed in the top view of the pull-down menu and can further be removed from that top view after the specified time period. FIG. 8 illustrates a screen shot of a pull-down menu displaying the three most recently visited links 505, 605, 705 as described above in accordance with exemplary embodiments. FIG. 8 further illustrates an Add Favorites selection 810 and an Organize Favorites selection 820 as known in the art. In exemplary embodiments, the pull-down menu 800 can further include a View Favorites Options selection 830 as further described here. In exemplary embodiments, the View Favorites Options selection 830 enables a user to select dynamic view options in accordance with exemplary embodiments and as further described herein. In exemplary embodiments, a user can further select to place all of the recently viewed links in a separate pull-down menu different from the conventional pull-down menu.

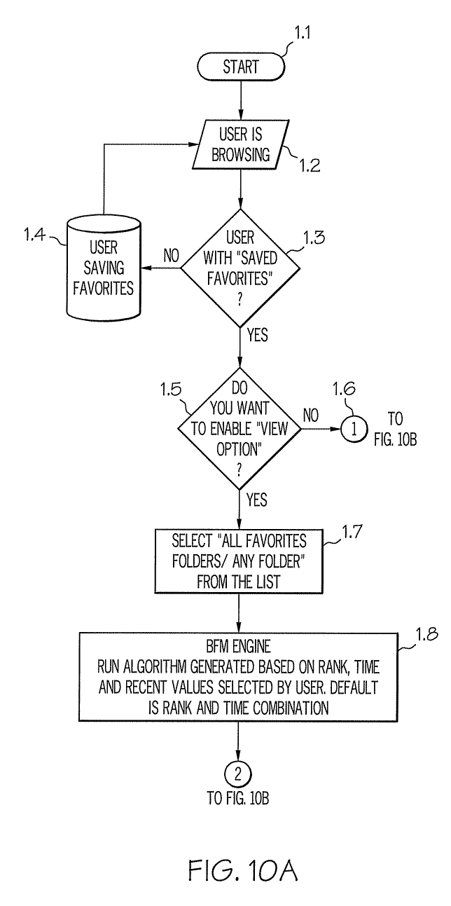

In exemplary embodiments, an algorithm can be implemented to dynamically organize the links as described herein. FIG. 9 illustrates a table 900 defining an algorithm in accordance with exemplary embodiments. The table 900 includes Boolean Values (0 and 1) to generate the combination of RANK, TIME and RECENT as further described herein. In exemplary embodiments, the term “rank” refers to the integer number associated with each view occurrence of particular bookmark. As such, frequently viewed links have a higher RANK value. For example, if the following link is opened in the browser two times, then the rank is 2: https://Link-Example. Furthermore, in exemplary embodiments, the term “time” refers to the specific period users specify to set his Dynamic Browsing activities. For example, if the user sets Time Value=1 hour, the system captures all URL visited from Saved bookmarks in a period of one hour. In exemplary embodiments, the term “recent” has a “no” value and displays the most recent link at the top of all browsed activities. In exemplary embodiments, the term “BFM Engine” is the processing engine which generates Dynamic Bookmarks based on user specified “View Options” in Browser as according to the table 900.

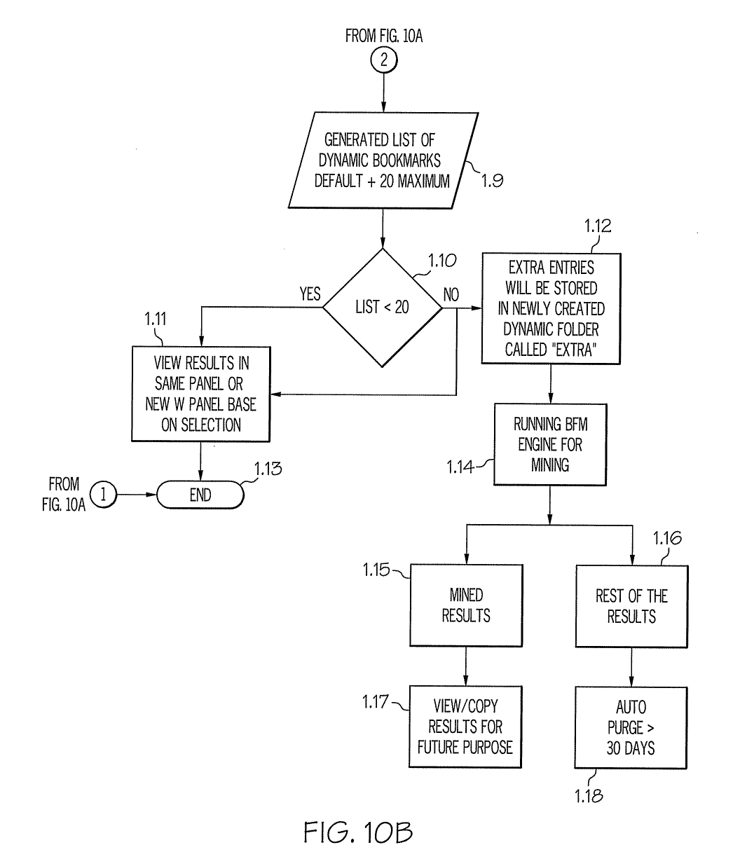

FIGS. 10A-10B illustrates a flowchart of a method 1000 for a dynamic display of saved bookmarks based on browsing activity in accordance with exemplary embodiments. At block 1.1, the method 1000 begins. At block 1.2, a user starts browsing by typing the URL in browser address bar/selecting saved favorites. At block 1.3, either the user is doing browsing first time and he has no “Saved Favorites” or the user has already “Saved Favorites” on the browser. At block 1.4, the favorites are saved. At block 1.5, the user has option to enable “View Option” of which the default is disabled. At block 1.6, if the user does not want to enable “View Option”, the user does not have to do anything. At block 1.7, if the user has Enabled “View Option” the user is selecting either “All Favorites/Bookmarks” folders or “any one of the Favorites/Bookmarks” folder. In exemplary embodiments, by default “All Favorites/Bookmarks” is selected. At block 1.8, based on the user's selection for “View Options” and user activity, the “BFM Engine” processes the user inputs. The table 900 includes detail on the BFM engine processing. At block 1.9, the BFM Engine creates list of dynamically generated bookmarks. In exemplary embodiments, the default setting for maximum entry is 20. At block 1.10, the method 1000 checks for the condition, list is <20. At block 1.11, if the list is <20, then the results in the same panel or another panel are displayed to the user as per user selection. At block 1.12, if the list is >20 then the first 20 entries are still displayed to the user and extra entries go under “Extra” folder to view at a later time. At block 1.13, the process flow ends. In exemplary embodiments, the blocks now described are optional for mining processes if the user wants to run multiple combinations of options.

Referring to FIG. 10B, at block 1.14, the BFM engine is processed on an “Extra” Folder. At block 1.15, the mined Results are generated. At block 1.16, any additional results are generated. At block 1.17, the results are viewed or copied for future purposes. At block 1.18, an auto purge features is set to delete old results.

In exemplary embodiments, the systems and methods described herein implement an additional browser plug-in that provides “View Options” section on browser through which user can set/select his/her own settings to achieve the desired behavior. For example, for INTERNET EXPLOER, the plug-in can be accessed via “Favorites” icon from Tool Bar and/or also from “Favorites” on Menu Bar. In another example, for the FIREFOX browser, the plug-in can be accessed via “Bookmarks” from Menu bar and/or also by clicking from “View”→“Sidebar”→“Bookmarks”. Referring again to FIG. 8, in exemplary embodiments, the “View Favorites” option 830 plug-in can include the following Radio Buttons. An Enable/Disable option can include: 1) Enable—To Enable “View Option” Feature; and 2) Disable—To Disable “View Option” Feature. In exemplary embodiments, the default option can be set to Disable. A Selecting Favorites/Bookmarks Folder Option can include a list of All Bookmark/Favorites folder. The methods described herein can be applied on All Bookmarks/Favorites or any specific folder. In exemplary embodiments, once the user selects the “Enable” option, the user has to select from the two choices as described above. In exemplary embodiments, the default is “All Bookmarks/Favorites”. The View Favorites option 830 can further include Selecting Options. In exemplary embodiments, one option is selected at a time via a radio button. In exemplary embodiments, the default option is “Option: 6 Rank && Time” (see FIG. 9, table 900). In exemplary embodiments, there are default values that are specified to some values. These defaults can be modified by user based on his requirement. In a first option, a “Recent” selection can be made, in which no further selection is required because all recent links are displayed. A “Time” option can be selected in which additional selections can be made. In one option, a particular number of hours can be selected. In another option, a particular number of days can be selected. It is appreciated that other time periods are contemplated in other exemplary embodiments. If the user selects the “Hour” option from, then the user can specify between 1 to 24 hours in an associated text Box. In exemplary embodiments, a default value is “8 Hours”. In exemplary embodiments, “Bookmarks” is generated based on the time specified, but it may or may not be in any specific order. This option simply captures all the bookmarks for that particular time and does not perform sorting. In another option, “Time & Recent”, two options can be presented to the user. As described above, the user can select a specific time in “Hours” or “Days”. If the user selects the “Hour” option from, then the user can specify between 1 to 24 hours in an associated text Box. In exemplary embodiments, a default value is “8 Hours”. In exemplary embodiments, “Bookmarks” is generated based on the time specified, and the Bookmarks are placed in a specific order. For example, most Recently viewed are placed at the top of the pull-down menu. As such, the method sorts based on whichever link is viewed recently. In still another option, the user can select “Rank” in which the user can specify the number of days and can restrict the limit of results. In still another option, the user can select “Rank & Recent”, which includes no further options. In another option, the user can select “Rank & Time”, in which the user can specify time values. Similar to as above, if the user selects the “Hour” option from, then the user can specify between 1 to 24 hours in an associated text box. In exemplary embodiments, a default value is “8 Hours”. In another option, the user can select “Rank & Time & Recent” in which the user can specify time values. Similar to as above, if the user selects the “Hour” option from, then the user can specify between 1 to 24 hours in an associated text box. In exemplary embodiments, a default value is “8 Hours”.

In exemplary embodiments, the system 100 can be implemented to specify view results. In exemplary embodiments, the user can select from two options. In one option, the system adds a link of Dynamically Generated Favorites/Bookmarks on the existing section starting from top. In another option, the system 100 creates a new section with a heading “Dynamic” next to original in which Favorites/Bookmarks are displayed. In exemplary embodiments, the user can also specify default viewable entries here. For example default maximum entries are set to 20.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In a computer system having a graphical user interface including a display and a selection device, a method for dynamically displaying bookmarks based on browsing activity, the method consisting of:
receiving a set of menu entries for a bookmark menu, each of the menu entries representing a bookmark, the menu entries having a first position and a bottom nth position;
displaying the set of menu entries on the display;
for each menu entry of the set of menu entries that is selected:
receiving a menu entry selection signal indicative of the selection device pointing at a selected menu entry from the set of menu entries;
in response to the menu entry selection signal, navigating to a network address associated with the menu entry; and
placing the selected menu entry at the first position.

2. The method as claimed in claim 1 wherein the bookmark menu includes previously stored bookmark menu entries that are moved toward the bottom position in response to the selected menu entry being placed at the first position.

3. The method as claimed in claim 2 wherein the selected menu entries are new entries in the previously stored bookmark menu entries.

4. The method as claimed in claim 3 wherein the new entries are displayed in a set of newly stored bookmark menu entries.

5. The method as claimed in claim 4 further consisting of setting a time limit for which the new menu entries are displayed in at least one of the previously stored bookmark menu entries and the newly stored bookmark menu entries.
